(19) United States
(12) Patent Application Publication
(10) Pub. No.: US 2012/0232950 A1
(43) Pub. Date: Sep. 13, 2012

(54) SPEND ANALYSIS SYSTEM AND METHOD

(76) Inventors: Sanjay Kadkol, Mumbai (IN); Bikash Mohanty, Mumbai (IN); Ashish Jha, Mumbai (IN); Aloysius Sebastian, Mumbai (IN)

(21) Appl. No.: 13/113,034

(22) Filed: May 21, 2011

(30) Foreign Application Priority Data
Mar. 11, 2011 (IN) 679/MUM/2011

(51) Int. Cl. G06Q 10/00

(52) U.S. Cl. 705/7.29

(57) ABSTRACT

System and method for spend analysis are provided. The method includes identifying a spend category and associating a cost component model to the spend category. The cost component model indicates one or more cost contributors to the spend category. The method also includes receiving market information associated with at least a subset of the one or more cost contributors in the cost component model and outputting an analysis of spend associated with the spend category in relation to the cost component model.

### CROSS-REFERENCES TO RELATED APPLICATIONS

The present invention claims priority to the Indian Patent Application No. 679/MUM/2011, titled “Spend Analysis System and Method”, filed Mar. 11, 2011; which is herein incorporated by reference.

### BACKGROUND OF THE INVENTION

The present invention is generally related to techniques for procurement of material and services in organizations. Procurement costs (also called as “spend”) are often an important aspect of overall production and/or operational efficiency of the organization. It thus becomes desirable to optimize the procurement costs.

The procurement costs are also often tied to the market dynamics of the underlying commodities. Hence, optimizing the procurement costs often includes actions prompted by these market dynamics. To facilitate these actions, the procurement professionals need visibility into how the market dynamics affects the procurement costs.

The present invention provides improved techniques for procurement cost analysis, which facilitate optimizing the procurement costs in light of the market dynamics.

### SUMMARY OF THE INVENTION

It is an object of the present invention to provide spend analysis system and method. The techniques for spend analysis according to the present invention advantageously facilitate analysis of the procurement cost vis-à-vis market dynamics of the underlying commodities. This in turn can facilitate optimizing procurement costs, projecting future procurement costs, negotiation leverage with suppliers and so on. Moreover, in an embodiment, the present invention provides the spend analysis system that is based on readily available computing technologies.

In a specific embodiment of the present invention, a computer based system for spend analysis is provided. The system comprises a processor unit. Moreover, the system comprises a computer readable medium storing instructions. The instructions are executable by the processor unit to perform the steps of identifying a spend category and associating a cost component model to the spend category. The cost component model indicates one or more cost contributors to the spend category. Moreover, the instructions are executable by the processor unit to perform the steps of receiving market information associated with at least a subset of the one or more cost contributors in the cost component model and outputting an analysis of spend associated with the spend category in relation to the cost component model based at least in part on the market information. In alternative embodiments, associated methods for spend analysis are also provided.

These and other various objects, features, advantages, and benefits of the present invention can be more fully appreciated with reference to the detailed description and accompanying drawings that follow.

### BRIEF DESCRIPTION OF THE DRAWINGS

Embodiments of the present invention are illustrated in the figures of the accompanying drawings. The figures are provided to aid thorough understanding of the invention and are exemplary rather than limiting. Based on the present teachings, person of ordinary skill in the art can contemplate various alternatives, variations and modifications to the illustrated embodiments within the scope of the invention disclosed herein.

FIG. 1 illustrates an exemplary computer network environment appropriate for a specific embodiment of the present invention.

FIG. 2 illustrates an exemplary computer apparatus that can provide a computing platform to practice specific embodiments of the present invention.

FIG. 3 illustrates an exemplary schematic of a system for spend analysis according to a specific embodiment of the present invention.

FIG. 4 illustrates an exemplary flow of steps in a method for spend analysis according to a specific embodiment of the present invention.

FIG. 5 illustrates an exemplary computer screenshot which facilitates user to formulate a cost component model, according to an embodiment of the present invention.

FIG. 6 illustrates an exemplary cost analysis output for the cost component model, according to an embodiment of the present invention.

FIG. 7 illustrates an exemplary spend analysis output, according to an embodiment of the present invention.

### DETAILED DESCRIPTION OF THE INVENTION

Purchasing professionals in organizations often look for ways to optimize the procurement costs (spend). These costs are often tied to costs of the underlying commodities. As a result, commodities market dynamics has significant impact on the spending in the organization. Accordingly, the present invention provides techniques for spend analysis, which facilitate analysis of the impact of the commodities market dynamics on the procurement costs. This in turn enables the purchasing professionals to take actions to optimize the spend.

The following detailed description of the invention refers at various places to the accompanying drawings and specific environments, applications, platforms, examples, computer screenshots, and implementations. The detailed description is provided for thorough understanding of the present invention and is illustrative rather than limiting.

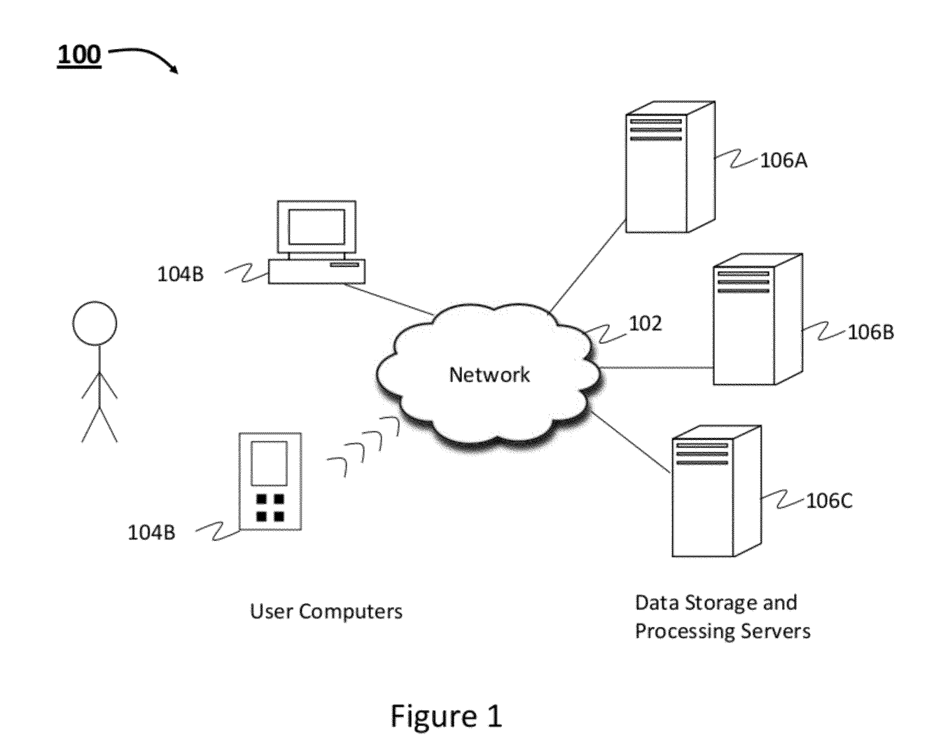

FIG. 1 illustrates an exemplary networked computer system 100 which can provide an environment to practice certain specific embodiments of the present invention. As shown in FIG. 1, multiple end user computer systems 104 and multiple server computer systems 106 can be coupled to a computer network 102. For example, the computer network 102 can be a private network of the organization. In alternative embodiment, the computer network 102 can include the local area network (LAN); and in yet an alternative embodiment it can include the Internet. The end user computer systems 104 can include without limitation desktop computers, laptop computers, personal digital assistant (PDAs), tablets, and smart phones. The computer systems 104, 106 etc. can exchange information using the computer network 102.

The servers 106 store digitized content which can be accessed (e.g., read, downloaded, searched, changed etc. as appropriate) over the computer network. A specific portion of the content is often identified using a hyperlink. The content stored in one server can also be accessed by another server and by the end user computer system. Popular techniques for accessing the content include HTTP and (HyperText Transfer Protocol) and HTTPS (HypterText Transfer Protocol Secure), though other techniques can also be used. Access to some portions of the content may require authentication and/or authorization for access.

Depending upon embodiments of the present invention, the servers 106 and the computer systems 104 can be configured to perform certain acts. For example, the servers 106 and the computer systems 104 can include software which can facilitate performing these acts. These acts can include various acts performed by the “spend analysis module”, by the “user interaction module”, by the “spend management module”, for interaction between the “spend analysis module” and the “user interaction module”, for interaction between the “spend analysis module” and the “spend management module” etc.

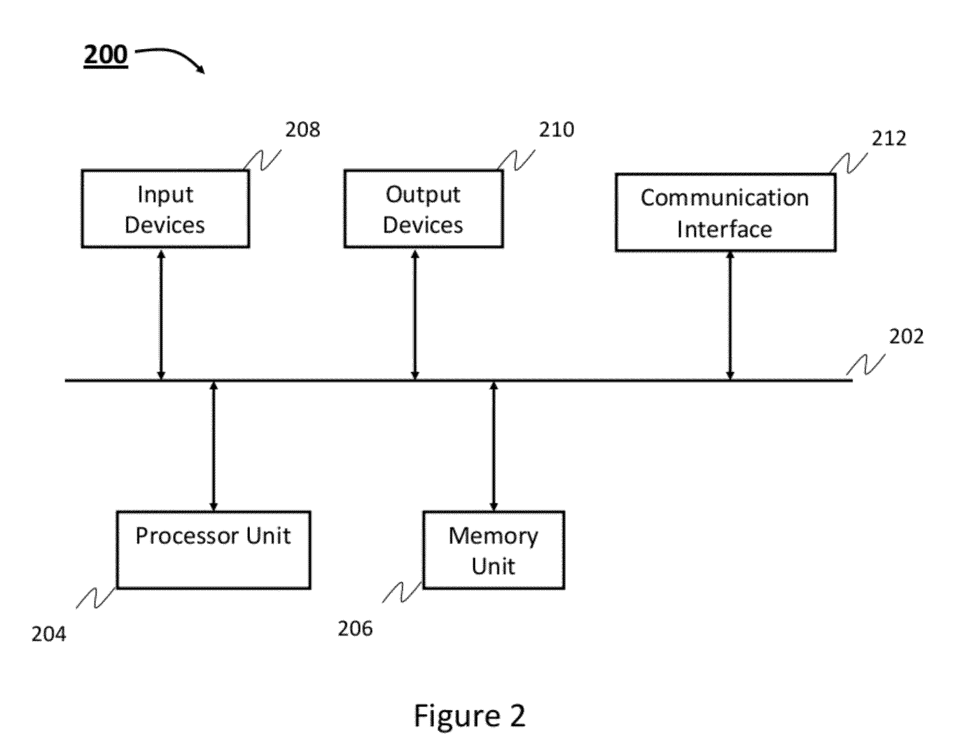

FIG. 2 illustrates an exemplary implementation of any of the servers 106 or any of the end user computer system 104, according to an embodiment of the present invention. The bus 202 permits communication among the components. The processor unit 204 may include one or more microprocessors, microcontrollers, RISC processors, CISC processors etc. The processor unit can interpret and execute instructions. The memory unit 206 may include any type of one or more volatile storage devices, for example, random access memory (RAM). The memory unit 206 may in addition or alternatively include any type of one or more persistent storage devices, for example read only memory (ROM), read write memory, hard disc, flash memory etc. The memory unit stores information and instructions for execution by the processor unit 204.

The input devices 208 may include one or more mechanisms that permit an operator to input information, such as a keyboard, mouse, pen, magnetic drives, optical drives etc. The output devices 210 may include one or more mechanisms that output information to the operator, including a display, a printer, a speaker etc. The communication interface 212 may include any transceiver mechanism that enables communication with other devices and systems via a network. For example, the communication interface can include Ethernet interface, optical network interface, wireless interface etc.

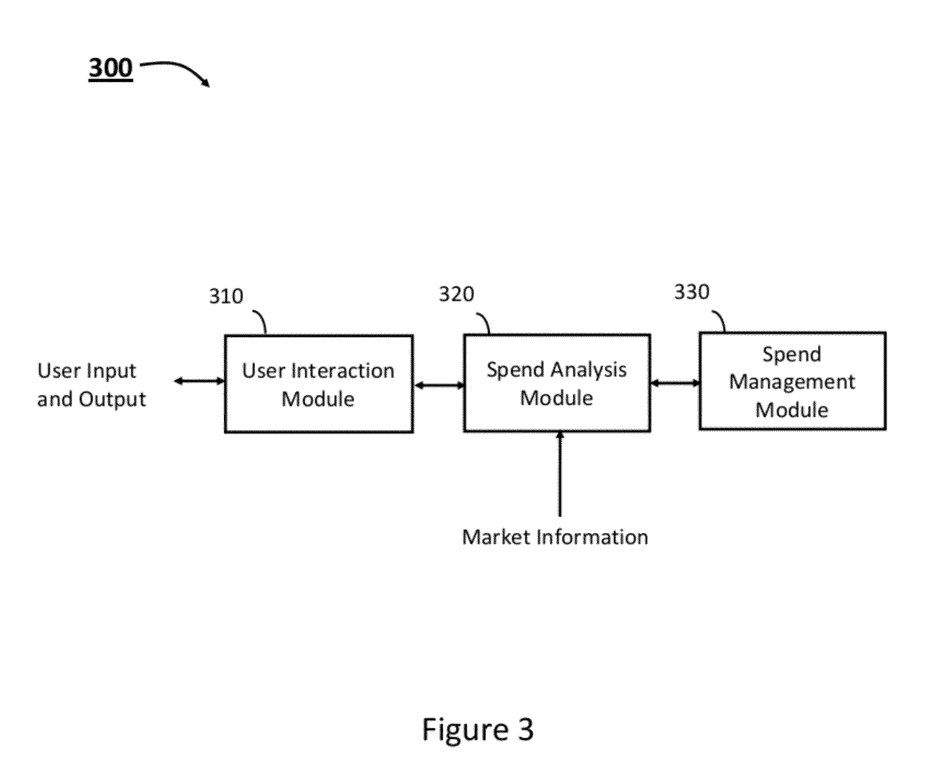

FIG. 3 illustrates an exemplary schematic 300 of a system for spend analysis according to an embodiment of the present invention. As shown in FIG. 3, the system 300 comprises various modules. Each of these modules can be a hardware module, a software module, or combination thereof. Moreover, depending upon the embodiment, each of the modules can reside on a single computer system or can be distributed across a plurality of interconnected computers. The user interaction module 310 provides interface between user and machine, and performs acts such as receiving input from user and providing output to the user. The spend management module 330 typically stores procurement information, which can identify various spend categories along with their past procurement records and future estimates. The spend analysis module 320 can perform various acts associated with analyzing the economics of the spend category.

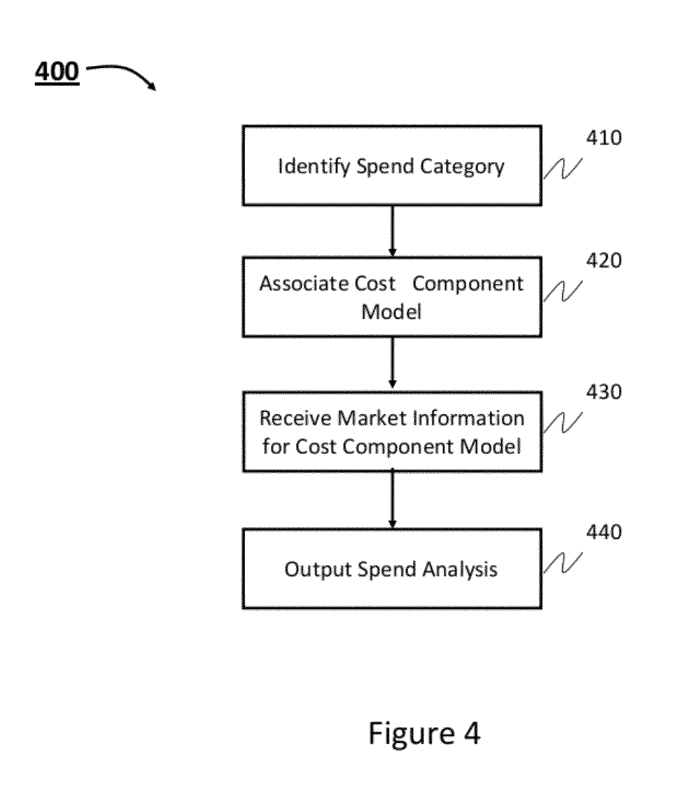

An exemplary flowchart 400 illustrating steps in a method for spend analysis according to an embodiment of the present invention is shown in FIG. 4. As shown in FIG. 4, the method can identify a spend category at step 410. According to an embodiment of the present invention which utilizes computer apparatus, the spend category can be identified by way of input from the user in a computer screen (for example, as facilitated by the user interaction module 310). In an alternative embodiment utilizing computer apparatus, the spend category can be identified by way of information received from the spend management module 330. In this embodiment, the spend analysis module 320 can issue one or more electronic queries to the spend management module and the spend management module can respond to the one or more queries identifying one or more spend categories.

Further at step 420, the method can associate a “cost component model” to the spend category. Preferably, the cost component model indicates one or more cost contributors to the spend category. The model can also indicate weightage or significance of a particular const contributor. As merely an example, the cost component model for the ball bearing can indicate the cost contributors are stainless steel, labor and electricity; and their weights or significance of contribution to the cost can be 40%, 16% and 10%, respectively. As yet another example, cost component model for a specific type of legal service can include hourly rate of lawyers as primary component (say, with 80% weight) and administrative overheads as secondary one (say, with 20% weight).

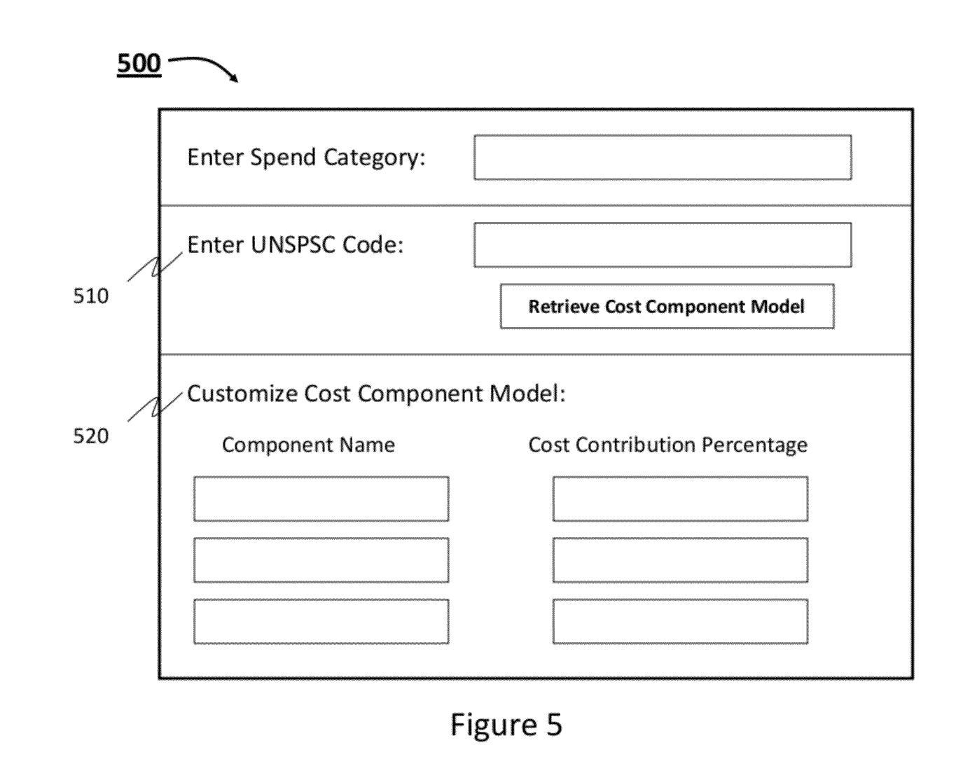

In an embodiment of the present invention which utilizes computer apparatus, the cost component model can be associated to the spend category by way of input from the user in a computer screen. In this embodiment, one or more pre-configured cost component models can be provided in the apparatus. The user can select the cost component model from these which is appropriate for the spend category of interest. In this embodiment, the user can also modify the selected pre-configured cost model to better suit the spend category. In an alternative embodiment, the user can formulate the cost component model for the spend category by way of selecting individual cost contributors and assigning weights to them (as illustrated in section 520, in the exemplary computer screenshot 500 in FIG. 5).

In an alternative embodiment, the cost component model can be assigned to the spend category based upon classification code for the spend category. As merely an example, UNSPSC (United Nations Standard Products and Services Code) is a coding system to classify products and services for use in electronic commerce (e-commerce). In this embodiment, the user can input the classification code for the spend category in a computer screen and the cost component model for that classification code is then associated to the spend category (as illustrated in section 510, in the exemplary computer screenshot 500 in FIG. 5).

The process of assigning the component cost models based upon the product/service classification codes is particularly advantageous to automatically assign the cost component models to the spend category information received from the spend management module as described before. In this embodiment, the spend management module can store the spend category information along with the classification codes for the spend categories according to a predetermined convention (such as UNSPSC); while the spend analysis module can store the cost component models for the classification codes (such as UNSPSC).

At step 430, the method can receive market information associated with the commodities in the cost component model for the spend category. The market information can include current cost of the commodity, historical cost of the commodity, future projected cost of the commodity etc. In an embodiment of the present invention which utilizes computer apparatus, the market information can be received by the spend analysis module over the computer network. In alternative embodiment, the market information can be retrieved from electronic media such as compact disc, hard disc, flash memory, RAM etc. and be made available to the spend analysis module.

As merely examples, the market information can be obtained from sources such as U.S. Energy Information Administration (EIA) which provides market information on petroleum and energy commodities/products, U.S. Department of Agriculture (USDA) which provides market information on agricultural commodities/products, U.S. Department of Labor Bureau of Labor Statistics (BLS) which provides market information on producer price index (PPI), consumer price index (CPI), labor rates and so on. The market information can also be obtained from other parties which aggregate and/or generate such information on their own. The market information can also be obtained from specialty market information providers which may focus on specific commodities/products. The sources of market information cited above are exemplary rather than limiting.

Moreover, at step 440 the method can output a spend analysis. The analysis can include spot analysis and/or trending analysis. The trending analysis can include past and/or future trending. In an embodiment of the present invention which utilizes computer apparatus, the analysis output can be provided to user by methods such as displaying on a computer screen, providing a file for downloading, providing a file for printing, emailing, archiving etc.

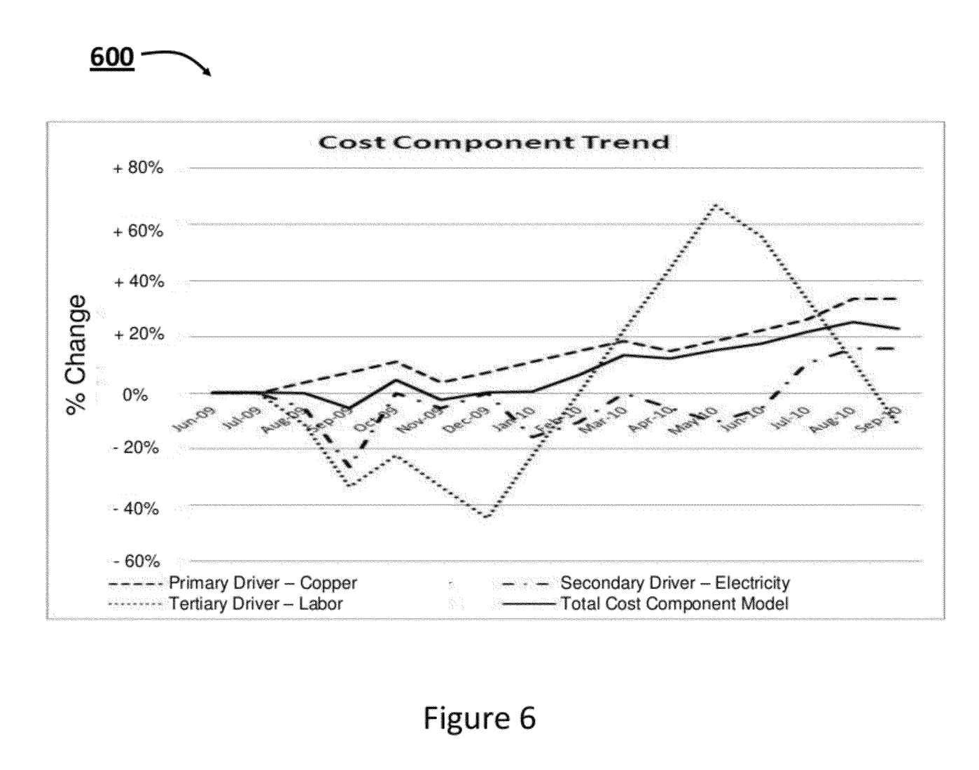

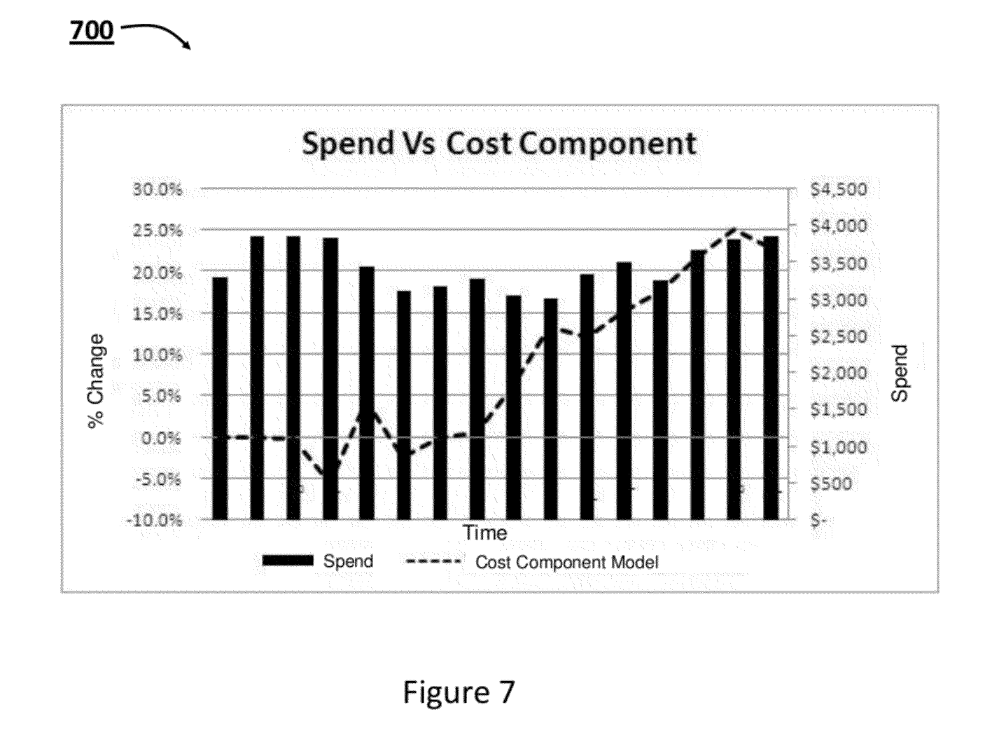

Certain exemplary analyses 600 and 700 outputted by the system according to an embodiment of the present invention are illustrated in FIG. 6 and FIG. 7, respectively. FIG. 6 illustrates trending analysis for the cost component model, including trending for individual cost contributors as well as aggregate trending, over a period of time. In an embodiment, the aggregate trend is obtained by combining individual trends in proportions of their significances to the cost contribution.

FIG. 7 illustrates trending analysis comparing the spend with the cost component model, over a period of time. The spend can be actual spend on the spend category performed in the past or it can be projected future spend, depending upon the embodiment. This exemplary illustration shows how the analysis output can be valuable to purchasing professional. Based on this example, the purchasing professional can tell that the spend was higher than it should have been in year 2009. This could be indication of overcharging by the supplier, supplier inefficiency etc.

In an embodiment, the present invention compares the cost component model trend with the spending trend. The difference between the cost component model trend and the spending trend can be computed and compared with a pre-determined threshold. When this difference crosses the pre-determined threshold, an alert can be generated. Such an alert facilitates the purchasing professional to initiate actions such as: re-negotiate with the supplier or change the supplier if the cost component model indicates that the spending trend is higher, re-budget for the procurement if the cost component model indicates that the spending trend is below the cost component model etc. In an embodiment of the present invention which utilizes computer apparatus, the comparison can be performed substantially automatically and substantially regularly. In this embodiment the alert can be communicated to the user via email, display on computer screen and so on.

Accordingly, the present invention provides a spend analysis system and method. While specific embodiments are described herein, alternative embodiments will be apparent to person of ordinary skill in the art, in which one or more acts described herein can be modified, performed in different order, or omitted; without departing from the spirit of the invention. Moreover, one or more acts can be added to those described herein. Such alternatives and modifications are included within the scope of the present invention.

What is claimed is:

1. A computer based system for spend analysis, the system comprising:
a processor unit;
a computer readable medium storing instructions executable by the processor unit to perform the steps of:
identifying a spend category;
associating a cost component model to the spend category, the cost component model indicating one or more cost contributors to the spend category;
receiving market information associated with at least a subset of the one or more cost contributors in the cost component model; and
outputting an analysis of spend associated with the spend category in relation to the cost component model, based at least in part on the market information.

2. The system of claim 1 wherein the cost component model further indicates relative significance of the one or more cost contributors to the spend category.

3. The system of claim 1 wherein the associating the cost component model including matching a classification code associated with the spend category to a classification code associated with the cost component model.

4. The system of claim 3 wherein the classification code being a UNSPSC (United Nations Standard Products and Services Code).

5. The system of claim 1 wherein the associating the cost component model including selecting a cost component model from a plurality of pre-configured cost component models.

6. The system of claim 5 wherein the selecting being responsive to a user input.

7. The system of claim 1 wherein the associating the cost component model including receiving formulation of the cost component model via a user input.

8. The system of claim 1 wherein the analysis includes a trending analysis of the spend in relation to the cost component model.

9. The system of claim 1 wherein the computer readable medium storing further instructions executable by the processor unit to perform the steps of:
comparing the spend with cost projected by the cost component model; and
generating an alert when difference between the spend and the cost projected by the cost component model crosses a pre-determined threshold.

10. A method for spend analysis, the method comprising:
identifying a spend category;
associating a cost component model to the spend category, the cost component model indicating one or more cost contributors to the spend category;
receiving market information associated with at least a subset of the one or more cost contributors in the cost component model; and
outputting an analysis of spend associated with the spend category in relation to the cost component model, based at least in part on the market information.

11. The method of claim 10 wherein the cost component model further indicates relative significance of the one or more cost contributors to the spend category.

12. The method of claim 10 wherein the associating the cost component model including matching a classification code associated with the spend category to a classification code associated with the cost component model.

13. The method of claim 12 wherein the classification code being a UNSPSC (United Nations Standard Products and Services Code).

14. The method of claim 10 wherein the associating the cost component model including selecting a cost component model from a plurality of pre-configured cost component models.

15. The method of claim 14 wherein the selecting being responsive to a user input.

16. The method of claim 10 wherein the associating the cost component model including receiving formulation of the cost component model via a user input.

17. The method of claim 10 wherein the analysis includes a trending analysis of the spend in relation to the cost component model.

18. The method of claim 10 further comprising:
comparing the spend with cost projected by the cost component model; and
generating an alert when difference between the spend and the cost projected by the cost component model crosses a pre-determined threshold.

19. A method for spend analysis, the method comprising:
identifying a spend category;
associating a cost component model to the spend category, the cost component model indicating one or more cost contributors to the spend category; and
receiving an analysis of spend associated with the spend category in relation to the cost component model, wherein the analysis is based at least in part on market information associated with at least a subset of the one or more cost contributors in the cost component model.

20. The method of claim 19 wherein the analysis includes a trending analysis of the spend in relation to the cost component model.
